(19) United States
(12) Patent Application Publication
(10) Pub. No.: US 2015/0304216 A1
(43) Pub. Date: Oct. 22, 2015

(54) CONTROL METHOD, CONTROL APPARATUS, COMMUNICATION SYSTEM, AND PROGRAM

(71) Applicant: NEC CORPORATION, Minato-ku, Tokyo (JP)

(72) Inventors: Kazuya SUZUKI, Tokyo (JP); Hideyuki SHIMONISHI, Tokyo (JP); Daisuke KOTANI, Tokyo (JP)

(73) Assignee: NEC Corporation, Tokyo (JP)

(21) Appl. No.: 14/372,199

(22) PCT Filed: Oct. 31, 2012
(86) PCT No.: PCT/JP2012/006990

§ 371 Date: Jul. 14, 2014

(30) Foreign Application Priority Data
Jan. 30, 2012 (JP) 2012-016109

(51) Int. Cl. H04L 12/741; H04L 12/18

(52) U.S. Cl. CPC H04L 45/74; H04L 12/18

(57) ABSTRACT

A control apparatus includes: a path calculation unit that calculates first and second paths sharing start and end nodes out of a plurality of nodes; a rule generation unit that generates a first rule for forwarding a packet along the first path and a second rule for forwarding a packet along the second path; and a rule transmission unit that sends the first and the second rules to at least one of the nodes, and has at least one of the nodes forward a packet according to either the first rule or the second rule.

### CROSS-REFERENCE TO RELATED APPLICATIONS

The present application claims priority from Japanese Patent Application No. 2012-016109 (filed on Jan. 30, 2012) the content of which is incorporated herein in its entirety by reference thereto. The present invention relates to a control method, control apparatus, communication system, and program, and particularly to a control method, control apparatus, communication system, and program that control the operation of a forwarding apparatus by transmitting a generated forwarding rule to the forwarding apparatus that forwards a packet according to forwarding rules.

### BACKGROUND

In recent years, centralized network architectures have been proposed. As an example of a centrally processed network architecture, there is a technology called OpenFlow.

In OpenFlow, packet forwarding is achieved by providing a node (forwarding apparatus) that processes a packet according to a processing rule and a control apparatus that controls the processing of the packet by sending a processing rule generated for the node in a network system (Non Patent Literatures 1 and 2). In OpenFlow, the node and the control apparatus are called “OpenFlow Switch” (OFS) and “OpenFlow Controller” (OFC), respectively. For instance, details of the OFS and the OFC are described in NPLs 1 and 2. A summary of the OFS and the OFC is given below.

The OFS comprises a flow table that performs a lookup for and forwarding of a packet, and a secure channel for communicating with the OFC. The OFC communicates with the OFS over the secure channel using the OpenFlow protocol, and controls a flow at, for instance, the API (Application Program Interface) level. For example, when a packet arrives at an OFS, this OFS searches the flow table based on the header information of the packet. When a processing rule (entry) matching the packet is found as a result of the search, the OFS processes the packet based on the matching processing rule. Meanwhile, when no processing rule matching the packet is found, the OFS requests a processing rule for processing the packet from the OFC.

In response to the request from the OFS, the OFC generates a processing rule for processing the packet. For instance, the OFC determines a path for forwarding the packet, and generates a processing rule for forwarding the packet based on the determined path. The OFC sends the generated processing rule to at least one OFS. For instance, the OFC sends the processing rule for forwarding the packet to an OFS related to the determined path.

For instance, for each flow, the flow table of the OFS has a rule (Rule) matching a packet header, action (Action) defining the processing for the flow, and flow statistic information (Statistics) as shown in FIG. 13.

For the Rule matching the packet header, an exact value (Exact) or wildcard (Wildcard) is used. The Action is processing content applied to a packet matching the Rule. The flow statistic information is also called “activity counter” and includes, for instance, the numbers of active entries, packet lookups, and packet matches, the numbers of received packets and received bytes, and the duration in which the flow is active for each flow, and received packets, transmitted packets, received bytes, transmitted bytes, receive drops, transmit drops, receive errors, transmit errors, receive frame alignment errors, receive overrun errors, receive CRC (Cyclic Redundancy Check) errors, and collisions for each port.

A packet received by the OFS is checked to see if it matches a rule in the flow table, and when an entry matching the packet is found, the action of the matching entry is performed on the packet. When no matching entry is found, this packet is treated as a First Packet and forwarded to the OFC via the secure channel. The OFC transmits a flow entry that determines a packet path to the OFS. The OFS performs addition, changes, and deletion on flow entries thereof.

When the OFS looks for a matching rule in the flow table, a predetermined field of the header of a packet is used. For instance, information to be matched includes MAC DA (Media Access Control Destination Address), MAC SA (MAC Source Address), the Ethernet (registered trademark) type (TPID), VLAN ID (Virtual Local Area Network ID), VLAN TYPE (priority), IP SA (IP Source Address), IP DA (IP Destination Address), IP protocol, Source Port (TCP/UDP source port, or ICMP (Internet Control Message Protocol) Type), and Destination Port (TCP/UDP destination port, or ICMP Code) (refer to FIG. 14).

FIG. 15 shows action names and action contents as examples. OUTPUT means outputting to a designated port (interface). Further, the actions from SET_VLAN_VID to SET_TP_DST are actions to correct the fields of the packet header.

For instance, the OFS forwards a packet to a physical port and virtual port. FIG. 16 shows examples of the physical ports. IN_PORT is an action to output a packet to an input port. NORMAL is an action to perform processing using an existing forwarding path supported by the OFS. FLOOD is an action to forward a packet to all ports ready for communication (ports in a forwarding state) except for the port that the packet came in on. ALL is an action to forward a packet to all ports except for the port that the packet came in on. CONTROLLER is an action to encapsulate a packet and transmits it to the OFC. LOCAL is an action to transmit a packet to the local network stack of the OFS. A packet that matches a flow entry without any action designated is dropped (discarded).

FIG. 17 shows messages exchanged via the secure channel as examples. Flow-mod is a message from the OFC to the OFS to add, change, and delete a flow entry. Packet-in is a message sent from the OFS to the OFC and used for sending a packet that does not match any flow entry. Packet-out is a message sent from the OFC to the OFS and used for outputting a packet generated by the OFC from any port of the OFS. Port-status is a message sent from the OFS to the OFC and used for notifying a change in port status. For instance, if a failure occurs in a link connected to a port, a notification indicating a link-down state will be sent. Flow-Removed is a message sent from the OFS to the OFC and used for notifying the OFC that a flow entry has not been used for a predetermined period of time and it will be removed from the OFS due to timeout.

The summary of an operation example of the OFS and the OFC has been given above. Further, as a related technology, Patent Literature 1 describes a method for calculating a multicast tree for forwarding packets between nodes.

### CITATION LIST

### Patent Literature

### [PTL 1]

Japanese Patent Kokai Publication No. JP-P2011-166360A

### Non-Patent Literature

### [NPL 1]

McKeown, Nick, et al., “OpenFlow: Enabling Innovation in Campus Networks,” [online], Mar. 14, 2008, [searched on Jan. 20, 2012], the Internet <URL: http://www.openflowswitch.org//documents/openflow-wp-latest.pdf>.

### [NPL 2]

“OpenFlow Switch Specification Version 1.1.0 Implemented (Wire Protocol 0 x 02),” [online], Feb. 28, 2011, [searched on Jan. 20, 2012], the Internet <URL: http://www.openflowswitch.org/documents/openflow-spec-v1.1.0.pdf>.

### SUMMARY

### Technical Problem

The following analysis is given by the present inventor.

The control apparatuses described in PTL 1, and NPLs 1 and 2 determine a path for forwarding a packet in response to a request for a processing rule for processing the packet, and send a processing rule for realizing packet forwarding through this path to a node.

Therefore, for instance, when a failure occurs in a node on the path or a link between nodes making it impossible to forward the packet through this path, the control apparatus needs to determine a new path for forwarding the packet and send a new processing rule for realizing packet forwarding through the new path to a node.

As a result, from the time when packet forwarding is no longer possible on the path that has been used to the time when the control apparatus sends a new processing rule corresponding to a new path, packet forwarding is interrupted.

Therefore, there is a need in the art to reduce the interruption time of packet forwarding in a centralized network architecture when, for instance, a failure occurs in a node or a link between nodes making it impossible to forward a packet using the path that has been used. It is an object of the present invention to provide a control method, control apparatus, communication system, and program that contribute to cope with such need.

### Solution to Problem

A control method relating to a first aspect of the present disclosure comprises:

by a control apparatus, calculating first and second paths that share start and end nodes out of a plurality of nodes;
generating a first rule for forwarding a packet along the first path and a second rule for forwarding a packet along the second path;
sending the first and the second rules to at least one of the plurality of nodes; and
having at least one of the plurality of nodes forward a packet according to either the first rule or the second rule.

A control apparatus relating to a second aspect of the present disclosure comprises:

a path calculation unit that calculates first and second paths sharing start and end nodes out of a plurality of nodes;
a rule generation unit that generates a first rule for forwarding a packet along the first path and a second rule for forwarding a packet along the second path; and
a rule transmission unit that sends the first and the second rules to at least one of the plurality of nodes, and has at least one of the plurality of nodes forward a packet according to either the first rule or the second rule.

A program relating to a third aspect of the present disclosure causes a computer to execute:

calculating first and second paths that share start and end nodes out of a plurality of nodes;
generating a first rule for forwarding a packet along the first path and a second rule for forwarding a packet along the second path; and
sending the first and the second rules to at least one of the plurality of nodes, and having at least one of the plurality of nodes forward a packet according to either the first rule or the second rule.

Further, the program can be provided as a program product stored in a non-transitory computer-readable storage medium.

A communication system relating to a fourth aspect of the present disclosure comprises a plurality of nodes and a control apparatus.

The control apparatus includes: path calculation means that calculates first and second paths that share start and end nodes out of the plurality of nodes;
rule generation means that generates a first rule for forwarding a packet along the first path and a second rule for forwarding a packet along the second path; and
rule transmission means that sends the first and the second rules to at least one of the plurality of nodes.

At least one of the plurality of nodes forwards the packet according to either the first rule or the second rule.

### Advantageous Effects of Invention

According to the control method, control apparatus, communication system, and program relating to the present disclosure, they contribute to a reduction in the interruption time of packet forwarding in a centralized network architecture when a failure occurs in a node or a link between nodes.

### BRIEF DESCRIPTION OF DRAWINGS

FIG. 1 is a block diagram schematically showing a configuration of a control apparatus relating to the present disclosure as an example.

FIG. 2 is a block diagram showing a configuration of a control apparatus relating to a first exemplary embodiment as an example.

FIG. 3 is a drawing showing a network as an example in which nodes constitutes a redundant tree.

FIGS. 4A and 4B are drawings showing matching rules for normal and reserve trees in the network in FIG. 3.

FIG. 5 is a flowchart showing an operation of input packet processing by the control apparatus relating to the first exemplary embodiment as an example.

FIG. 6 is a flowchart showing an operation of the control apparatus relating to the first exemplary embodiment as an example when a received packet is a general multicast packet.

FIG. 7 is a flowchart showing an operation of the control apparatus relating to the first exemplary embodiment as an example when a received packet is a packet indicating participation in a multicast group.

FIG. 8 is a flowchart showing an operation of the control apparatus relating to the first exemplary embodiment as an example when a failure is detected.

FIG. 9 is a drawing showing a network as an example in which nodes constitutes a redundant tree.

FIG. 10 is a block diagram showing a configuration of a control apparatus relating to a second exemplary embodiment as an example.

FIG. 11 is a drawing showing a configuration of a path table in the control apparatus relating to the second exemplary embodiment as an example.

FIG. 12 is a flowchart showing an operation of packet reception by the control apparatus relating to the second exemplary embodiment as an example.

FIG. 13 is a drawing showing a flow table in an OpenFlow Switch (OFS).

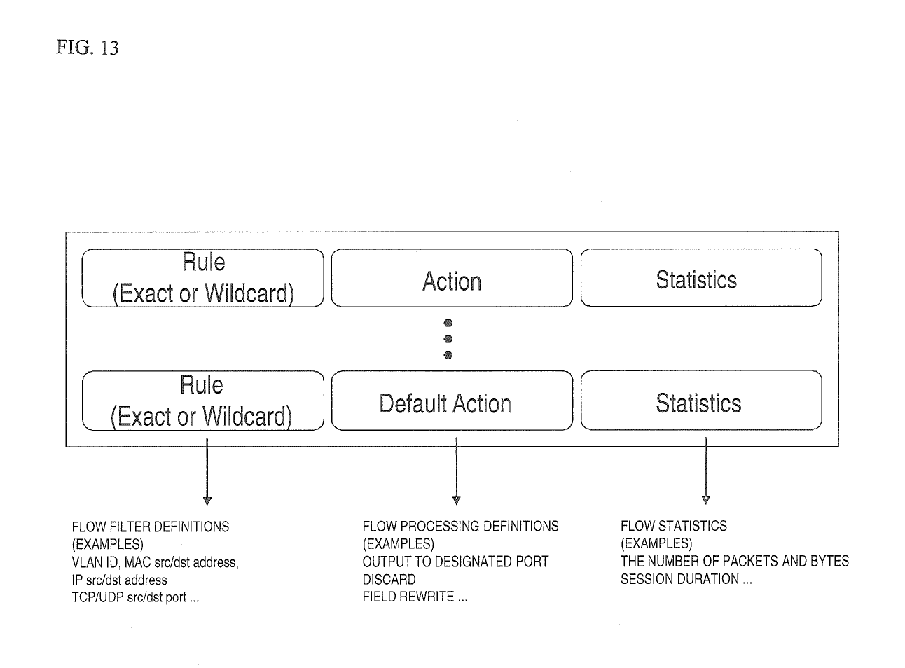

FIG. 14 is a drawing showing a header of an Ethernet/IP/TCP packet.

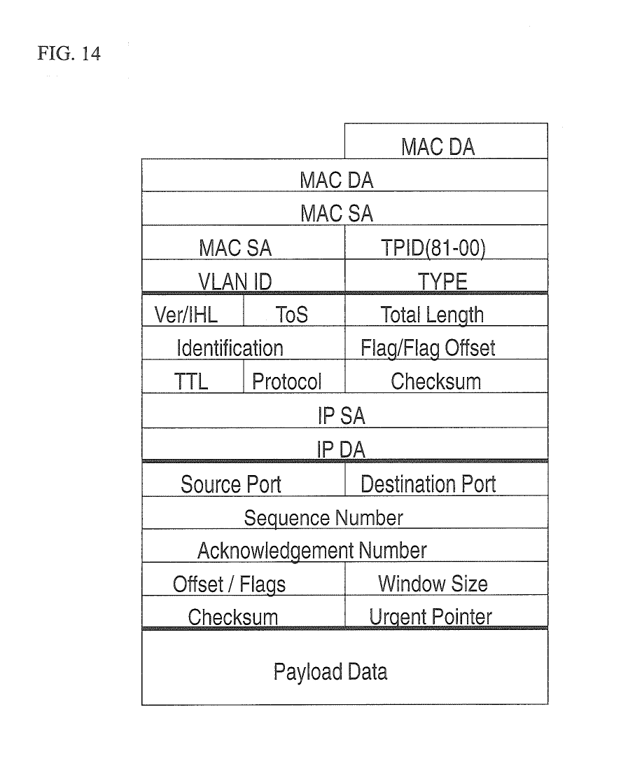

FIG. 15 is a drawing showing actions specifiable in a flow table of OpenFlow and the explanations thereof.

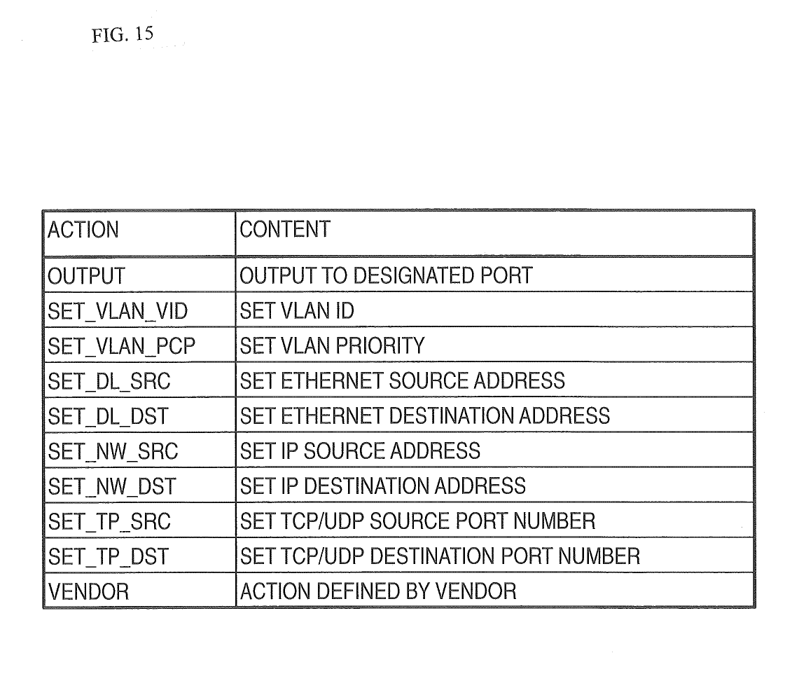

FIG. 16 is a drawing showing virtual ports specifiable as a destination in an action of OpenFlow and the explanations thereof.

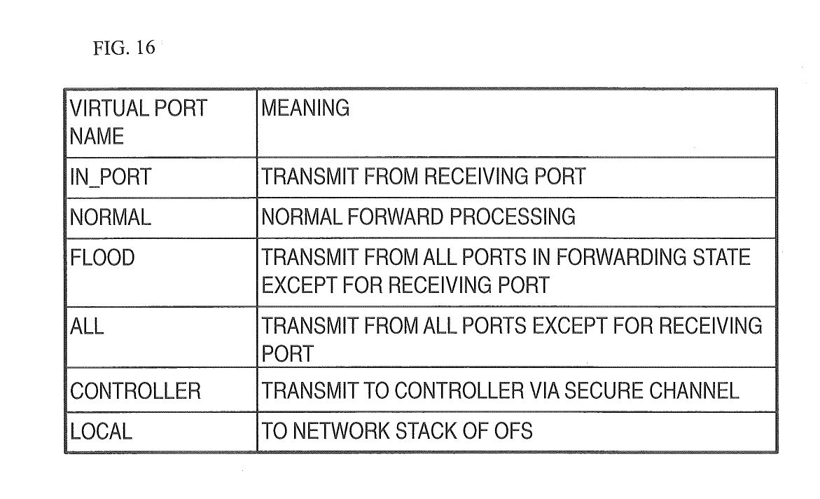

FIG. 17 is a drawing showing OpenFlow messages and the explanations thereof.

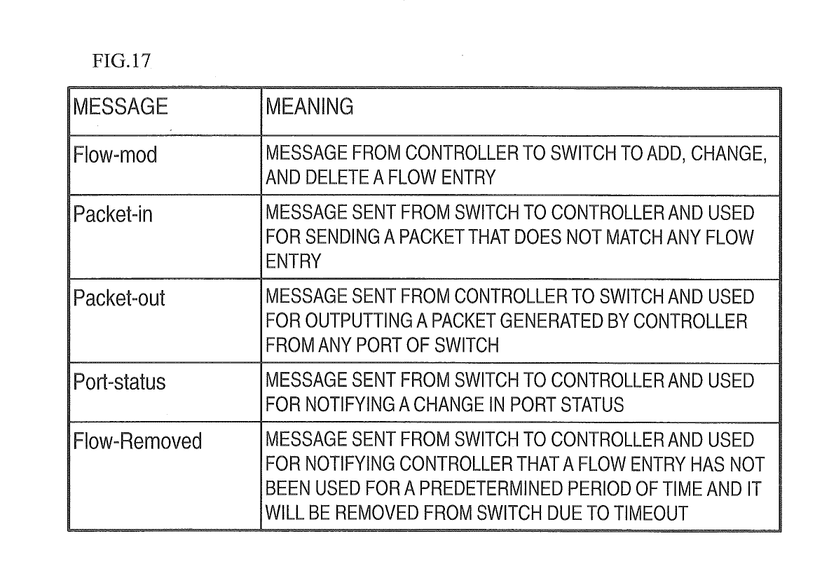

### DESCRIPTION OF EMBODIMENTS

First, a summary of the present disclosure will be given. Note that the drawing reference signs used in the summary are given solely to facilitate understanding and not to limit the present disclosure to the illustrated aspects.

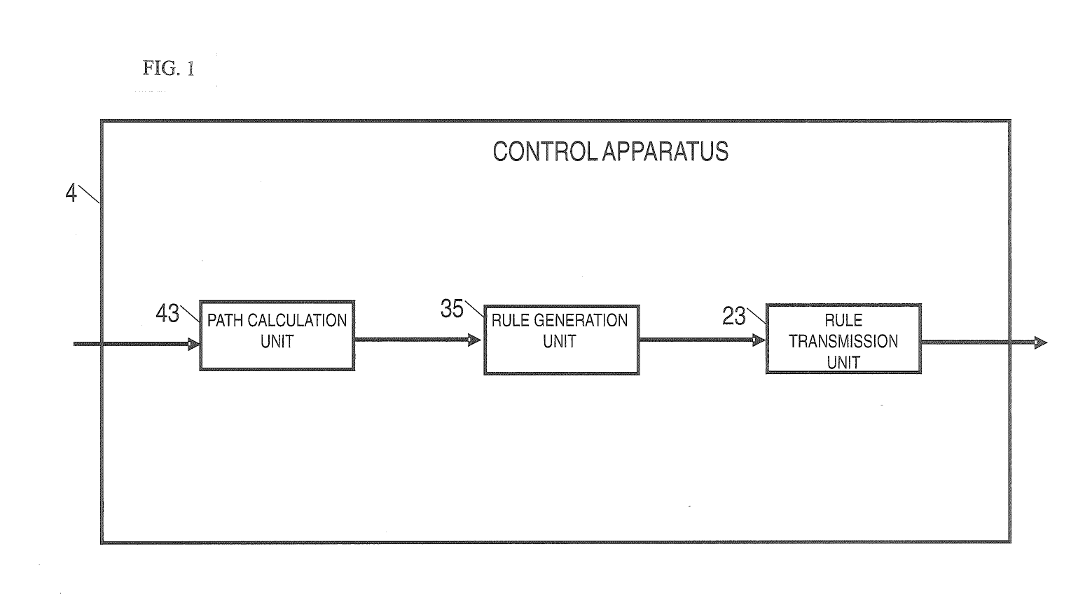

FIG. 1 is a block diagram schematically showing a configuration of a control apparatus (4) relating to the present disclosure. With reference to FIG. 1, the control apparatus (4) comprises a path calculation unit (43), a rule generation unit (35), and a rule transmission unit (23).

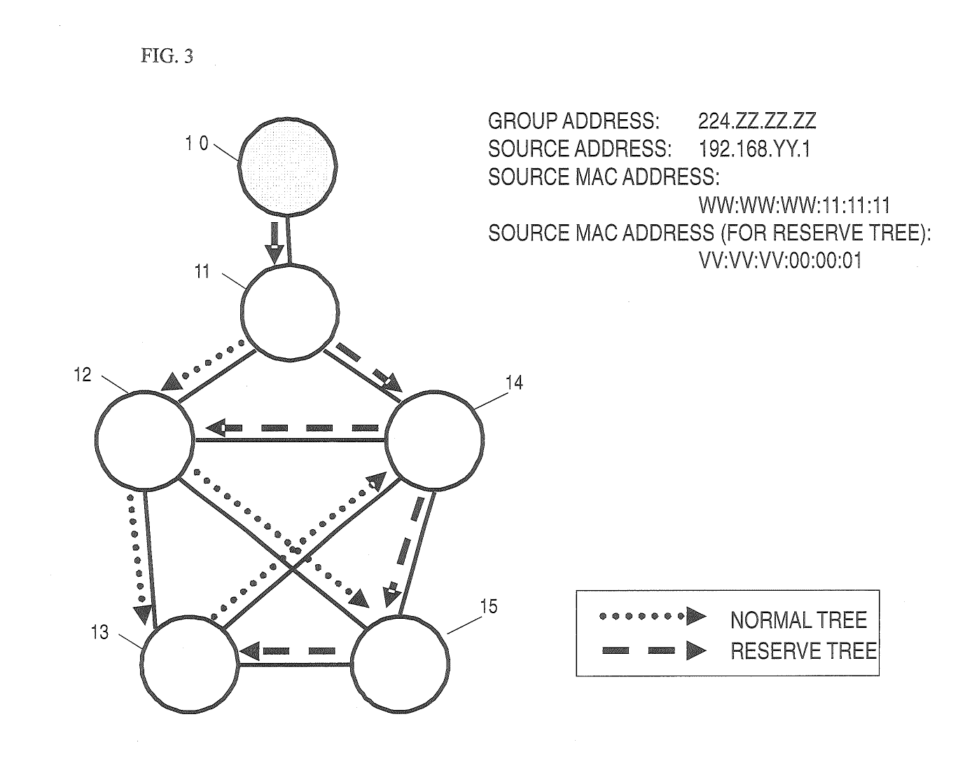

FIG. 3 illustrates nodes (11 to 15), and packet forwarding by these nodes is controlled by a source node (10) and the control apparatus (4). Here, as an example, a case where a packet sent by the source node (10) is forwarded to a reception node (not shown in the drawing) connected to the node (15) will be described.

The path calculation unit (43) calculates first and second paths that share the start node (the node 11) and the end node (the node 15) out of the plurality of nodes (11 to 15). In FIG. 3, the first path is included in a normal tree that goes from the node 11 to the node 15 via the node 12. Meanwhile, the second path is included in a reserve tree that goes from the node 11 to the node 15 via the node 14.

The rule generation unit (35) generates a first rule for forwarding a packet along the first path and a second rule for forwarding a packet along the second path. The rule transmission unit (23) sends the first and the second rules to at least one of the plurality of nodes (11 to 15) and has at least one of the plurality of nodes (11 to 15) forward a packet according to at least one of the first and the second rules.

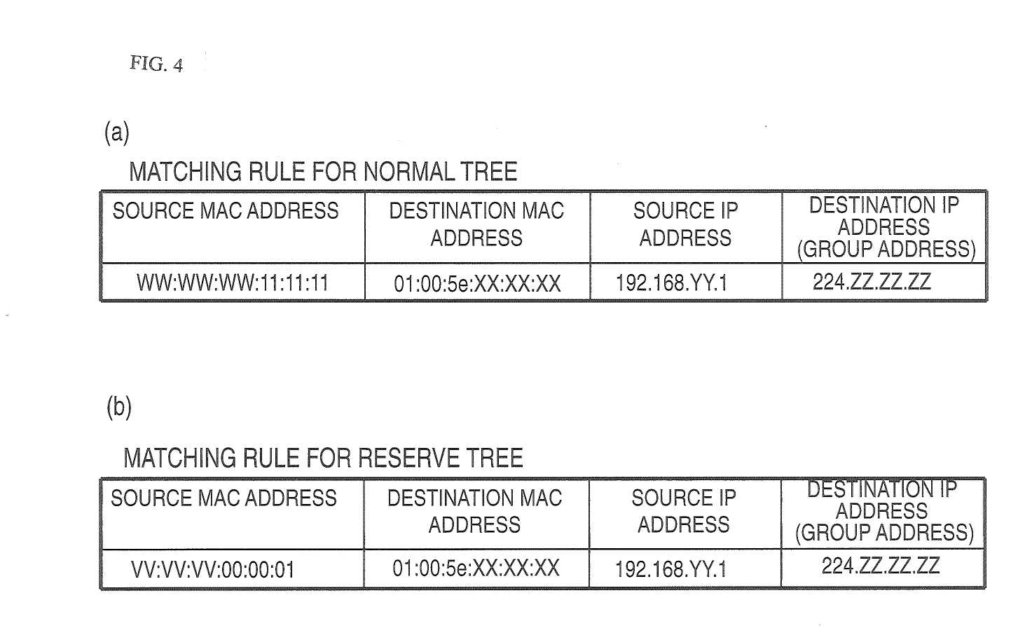

With reference to FIG. 4A, as a matching rule for a packet, the first rule includes a first identifier (for instance, source MAC address: WW:WW:WW:11:11:11) that identifies the first path. Further, with reference to FIG. 4B, as a matching rule for a packet, the second rule includes a second identifier (for instance, source MAC address: VV:VV:VV:00:00:01) that identifies the second path.

At this time, a packet having the first identifier included in the packet header is forwarded from the start node to the end node via the first path according to the first rule. Meanwhile, a packet having the second identifier included in the packet header is forwarded from the start node to the end node via the second path according to the second rule.

For instance, if a failure occurs in the node (12) or in the link between the node (11) and the node (12), packet forwarding can be continued by switching the packet forwarding path from the first path to the second path. According to the control apparatus relating to the present disclosure, the first rule for forwarding a packet along the first path and the second rule for forwarding a packet along the second path are set in the nodes associated with each of the paths in advance. Therefore, for instance, the control apparatus (4) can simply switch the rule used for packet forwarding by the nodes (11 to 15) from the first rule to the second rule. In other words, according to the present disclosure, for instance, when a failure occurs, the control apparatus (4) does not need to perform the processing of calculating a new alternative path, generating a rule for forwarding a path along this new path, and setting the rule in at least one of the nodes (11 to 15). At this time, when a failure occurs in a node or a link between the nodes, the interruption time of packet forwarding can be reduced.

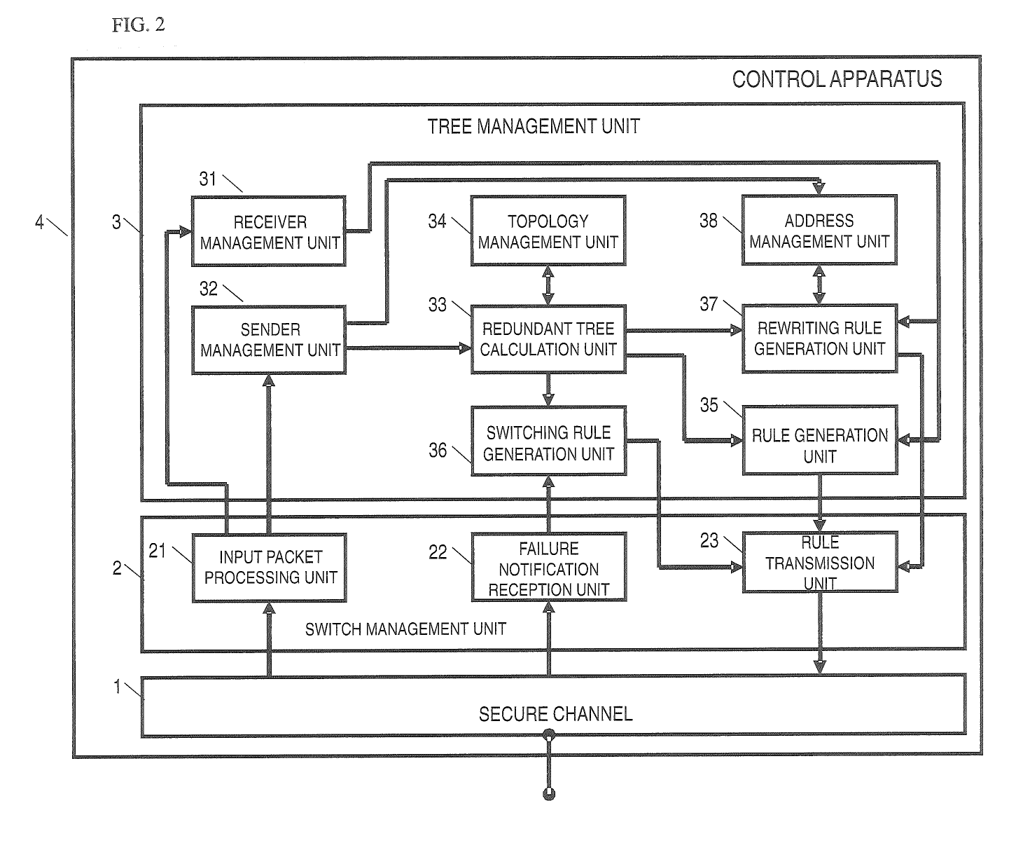

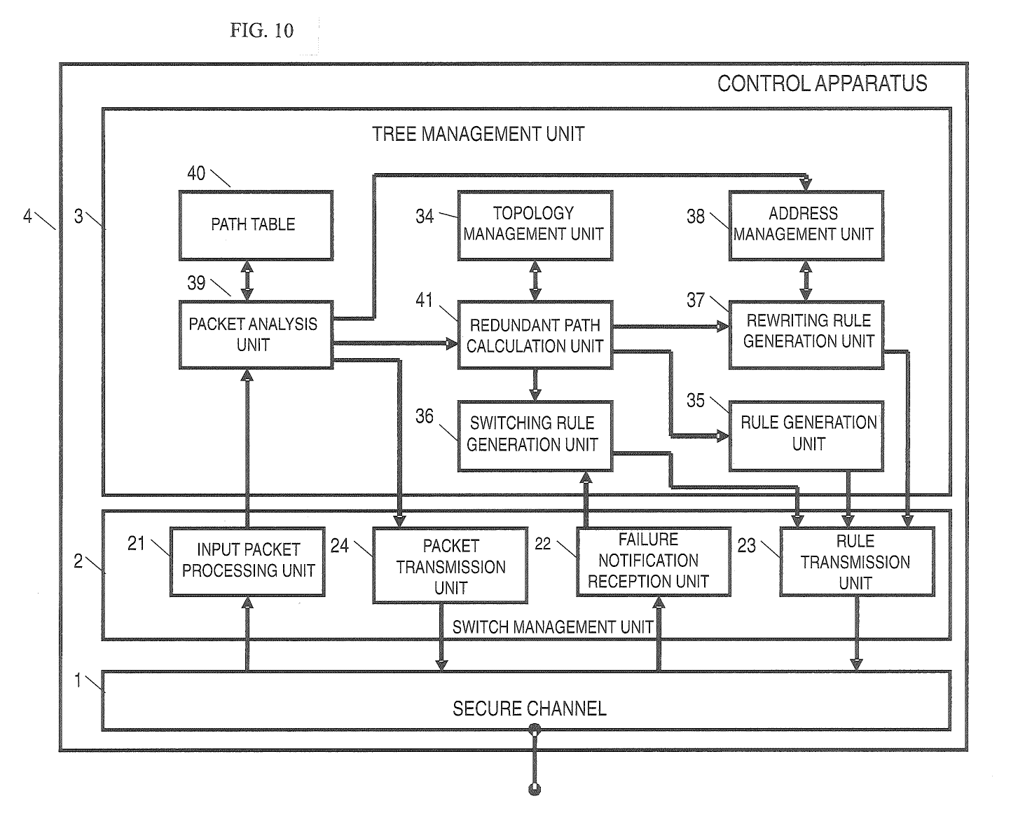

With reference to FIGS. 2 and 10, the control apparatus (4) may further comprise a switching rule generation unit (36). The switching rule generation unit (36) generates a third rule that rewrites a field included in the packet header of a packet from the first identifier (source MAC address: WW:WW:WW:11:11:11) to the second identifier (source MAC address: VV:VV:VV:00:00:01). Here, the third rule includes the first identifier (source MAC address: WW:WW:WW:11:11:11) as a matching rule for a packet. With reference to FIG. 3, the rule transmission unit (23) may sends the third rule generated by the switching rule generation unit (36) to the node (11) that corresponds to the start node among the plurality of nodes.

At this time, the node (11) rewrites a field included in the packet header of a packet from the first identifier to the second identifier. A packet having the second identifier in the packet header is forwarded via the second path according to the second rule since it matches the matching rule of the second rule. As described, according to the present disclosure, the packet forwarding path can be easily changed from the first forwarding path to the second forwarding path by simply sending the third rule to the node corresponding to the start node.

With reference to FIGS. 2 and 10, the control apparatus (4) may further comprise a failure notification reception unit (22). The failure notification reception unit (22) detects a failure in a plurality of nodes or a link between a plurality of nodes. The switching rule generation unit (36) may generate the third rule when a failure is detected in the first path.

With reference to FIGS. 2 and 10, the control apparatus (4) may further comprise a rewriting rule generation unit (37). The rewriting rule generation unit (37) generates a fourth rule that rewrites a field included in the packet header of a packet from the second identifier (source MAC address: VV:VV:VV:00:00:01) to the first identifier (source MAC address: WW:WW:WW:11:11:11). Here, the fourth rule includes the second identifier (for instance, source MAC address: VV:VV:VV:00:00:01) as a matching rule for a packet. The rule transmission unit (23) may send the fourth rule to the node (15) corresponding to the end node among the plurality of nodes.

At this time, regarding a packet having a field value included in the packet header and rewritten by the node (11) from the first identifier to the second identifier, the node (15) is able to write back this field value from the second identifier to the first identifier.

The control apparatus relating to the present disclosure calculates a path to be used after a failure occurrence, and sets in advance a rule that realizes packet forwarding along the calculated path in a node. It becomes possible to greatly reduce packet loss, compared to the case where the control apparatus is capable of quickly switching the path at the time of a failure and generates and sets a rule in a node after a failure occurrence.

### First Exemplary Embodiment

A control apparatus relating to a first exemplary embodiment will be described with reference to the drawings.

FIG. 2 is a block diagram showing a configuration of the control apparatus 4 relating to the present exemplary embodiment as an example. With reference to FIG. 2, the control apparatus 4 comprises a secure channel 1 that communicates with each node (switch) in a network, a switch management unit 2, and a tree management unit 3. Further, the switch management unit 2 comprises an input packet processing unit 21, the failure notification reception unit 22, and the rule transmission unit 23. Further, the tree management unit 3 comprises a receiver management unit 31, a sender management unit 32, a redundant tree calculation unit 33, a topology management unit 34, the rule generation unit 35, the switching rule generation unit 36, the rewriting rule generation unit 37, and an address management unit 38.

The input packet processing unit 21 operates when an input packet to a node is sent to the control apparatus 4 via the secure channel 1. The input packet processing unit 21 determines the type of the packet. When the packet is a normal multicast packet, the input packet processing unit 21 transmits the packet to the sender management unit 32. Meanwhile, when the packet is a packet that indicates participation in a multicast group transmitted by a multicast receiver (multicast receiver terminal), the input packet processing unit 21 transmits the packet to the receiver management unit 31.

For instance, a packet indicating participation in a multicast group transmitted by a multicast receiver (multicast receiver terminal) is a packet of the protocol called IGMP (Internet Group Management Protocol) in IPv4 (IP version 4), and it is a packet of the protocol called MLD (Multicast Listener Discovery) in IPv6 (IP version 6).

When a failure notification from a node is sent to the control apparatus 4 via the secure channel, the failure notification reception unit 22 sends the content of the notified failure to the switching rule generation unit 36.

The rule transmission unit 23 transmits a rule sent from any one of the rule generation unit 35, the switching rule generation unit 36, and the rewriting rule generation unit 37 to each node via the secure channel 1.

The receiver management unit 31 sends a group address in an IGMP or MLD packet sent from the input packet processing unit 21, the ID of the node that has received the packet, and the ID of the receiving port to the rewriting rule generation unit 37 and the rule generation unit 35.

Out of the information sent from the input packet processing unit 21, the sender management unit 32 sends the source address and the group address of the packet, and the IDs of the node that has received the packet and the receiving port to the redundant tree calculation unit 33. Further, out of the information sent from the input packet processing unit 21, the sender management unit 32 sends the source address, the group address, and the source MAC address of the packet to the address management unit 38.

The redundant tree calculation unit 33 calculates a redundant tree comprised of a pair of normal and reserve trees for each pair of the packet source and group addresses and sends it to the rule generation unit 35.

FIG. 3 illustrates how the redundant tree including the normal tree (the dotted line) and the reserve tree (the dashed line) is configured in a network including the nodes 11 to 15. The source node 10 connected to the node 11 has a source address of 192.168.YY.1. The redundant tree is configured for a multicast sent from the source node 10 as a group address 224.ZZ.ZZ.ZZ.

The topology management unit 34 manages the topology information of the network constituted by the nodes managed by the control apparatus 4, and provides the redundant tree calculation unit 33 with the topology information. The topology information includes information regarding the nodes included in the network and information indicating how the nodes are connected to each other. These pieces of information may be manually stored in the topology management unit 34 by the administrator in advance. Further, after autonomously collecting the information using some sort of means, the control apparatus 4 may store it in the topology management unit 34.

The rule generation unit 35 generates a rule for the members of each group address of the multicast sent from the receiver management unit 31 so that the packet from the source will reach along the redundant tree calculated by the redundant tree calculation unit 33, and sends the rule to the rule transmission unit 23.

FIGS. 4A and 4B show matching rules in the rules for the redundant tree shown in FIG. 3 as examples. The multicast packet outputted by the source node in FIG. 3 has the source MAC address of WW:WW:WW:11:11:11, a destination MAC address of 01:00:5e:XX:XX:XX, the source IP address of 192.168.YY.1, and the group address of 224.ZZ.ZZ.ZZ. Therefore, these values are used as the matching rules for the normal tree. Meanwhile, the matching rules for the reserve tree differ from the matching rules for the normal tree in that the address VV:VV:VV:00:00:01 assigned by the control apparatus 4 to the reserve tree is used as the matching rule for the source MAC address.

In FIG. 3, the next nodes after the node 11 in the normal tree and the reserve tree are the nodes 12 and 14, respectively. In other words, the rule generation unit 35 generates for the node 11 a rule including an action of outputting a packet that matches the matching rules in FIG. 4A from a port connected to the node 12. Similarly, the rule generation unit 35 generates for the node 11 a rule including an action of outputting a packet that matches the matching rules in FIG. 4B from a port connected to the node 14. The rule generation unit 35 similarly generates rules for the other nodes 12 to 15.

The switching rule generation unit 36 generates a rule for rewriting the source MAC address to switch the forwarding path from the normal tree to the reserve tree when the failure notification reception unit 22 receives a failure notification, and sends the rule to the rule transmission unit 23.

In the case of the network shown in FIG. 3, the matching rules of this rule for rewrite are the same as the matching rules shown in FIG. 4A. Further, the action for a packet that matches these matching rules is to “rewrite the source MAC address to VV:VV:VV:00:00:01.” By sending this rule to the node 11 in FIG. 3, the source MAC address is rewritten from WW:WW:WW:11:11:11 to VV:VV:VV:00:00:01. The packet having the source MAC address rewritten is forwarded using the reserve tree set by the rule generation unit 35 in advance since it matches the matching rules in FIG. 4B.

For the members of each group address of the multicast sent from the receiver management unit 31, the rewriting rule generation unit 37 generates a rule that writes the source MAC address back to the original address in the edges of the reserve tree in the redundant tree calculated by the redundant tree calculation unit 33, and sends the rule to the rule transmission unit 23.

The address management unit 38 holds on to a set of the source address, the destination address (group address), and the source MAC address of a packet sent from the sender management unit 32, and returns the source MAC address in response to the rewriting rule generation unit 37.

Next, the operation of the control apparatus 4 of the present exemplary embodiment will be described with reference to the drawings.

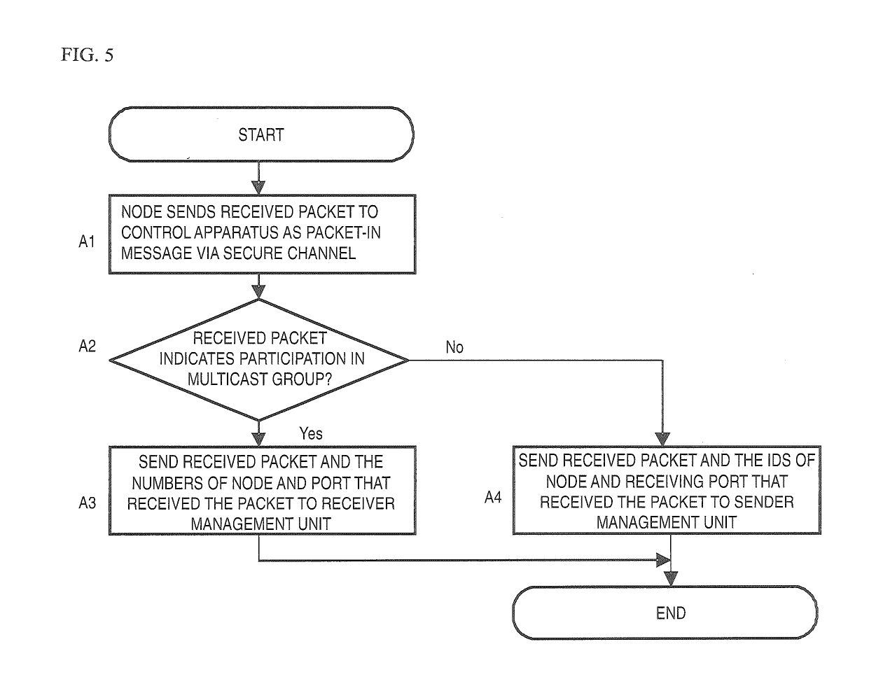

First, an operation of receiving a packet will be described with reference to a flowchart shown in FIG. 5. A node sends a received packet to the control apparatus as a Packet-in message via the secure channel (step A1).

The input packet processing unit 21 in the control apparatus 4 checks if the packet sent from the node as a Packet-in message is a packet indicating participation in a multicast group (step A2). More concretely, the input packet processing unit 21 checks if the packet is an IGMP packet in IPv4, and it checks if the packet is an MLD packet in IPv6. When the packet indicates participation in a multicast group (Yes in the step A2), the input packet processing unit 21 sends the packet and the numbers of the node and the port that received the packet to the receiver management unit 31 (step A3).

Meanwhile, when the packet does not indicate participation in a multicast group (No in the step A2), the input packet processing unit 21 sends the packet and the IDs of the node that received the packet and the receiving port to the sender management unit 32 (step A4).

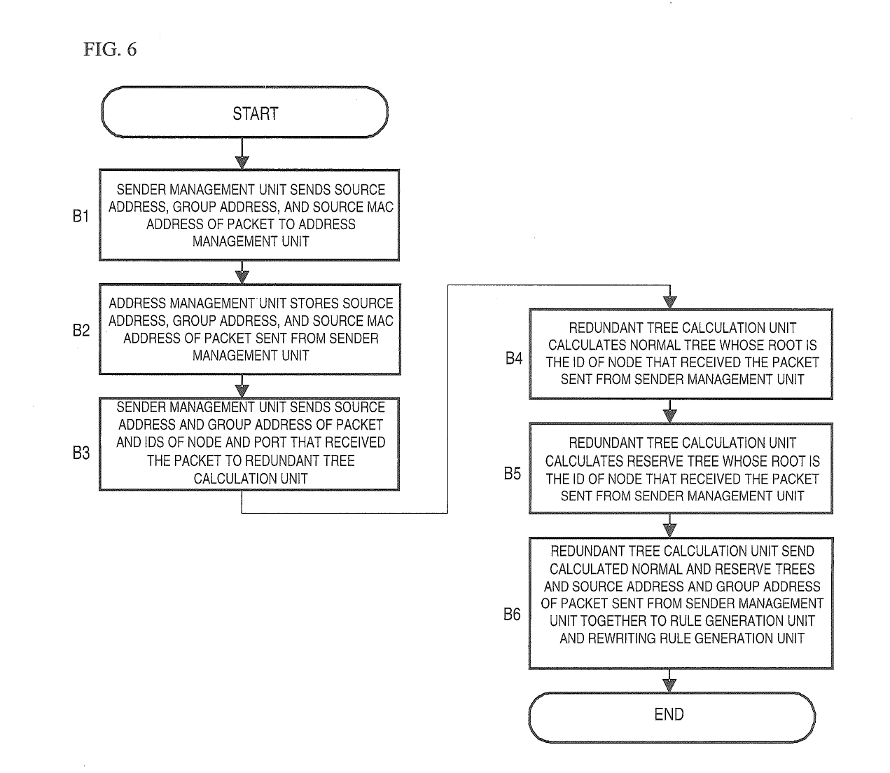

Next, an operation of the sender management unit 32 receiving a packet from the input packet processing unit 21 will be described with reference to a flowchart in FIG. 6.

The sender management unit 32 sends the source address, the group address, and the source MAC address of the packet to the address management unit 38 (step B1). Next, the address management unit 38 stores a set of information comprised of the source address, the group address, and the source MAC address of the packet sent from the sender management unit 32 (step B2). Then, the sender management unit 32 sends the source address and the group address of the packet and the IDs of the node and the port that received the packet to the redundant tree calculation unit 33 (step B3).

The redundant tree calculation unit 33 calculates the normal tree whose root is the ID of the node that received the packet sent from the sender management unit 32 (step B4). For instance, the redundant tree calculation unit 33 derives the minimum spanning tree from the root node to all the other nodes by applying Dijkstra's algorithm based on the topology information stored in the topology management unit 34. At this time, the redundant tree calculation unit 33 sets the cost of each link to “1” for example.

Next, the redundant tree calculation unit 33 calculates the reserve tree whose root is the ID of the node that received the packet sent from the sender management unit 32 (step B5). When calculating the reserve tree, the redundant tree calculation unit 33 may use Dijkstra's algorithm as it does when calculating the normal tree. However, the redundant tree calculation unit 33 sets a cost greater than “1” to the links used in the normal tree as a penalty.

A few methods can be used to come up with the cost value as the penalty. For instance, if the cost is infinite, the links used in the normal tree will not be used in the reserve tree. In this case, however, it may not be possible to construct the reserve tree that includes all the nodes, depending on the topology. Therefore, one can conceive a method that uses the total of the weights of all the links as the cost value used in the reserve tree. In this case, the reserve tree is constructed while the links used in the normal tree are avoided as much as possible, but when there is no other choice, the links used in the normal tree are used as well.

Next, the redundant tree calculation unit 33 combines the calculated normal and reserve trees and the source address and the group address of the packet sent from the sender management unit 32, and sends them to the rule generation unit 35 and the rewriting rule generation unit 37 (step B6).

Here, as an example, the calculation method based on Dijkstra's algorithm was described as the method for calculating the redundant tree. However, as an algorithm other than Dijkstra's, the algorithm described in Patent Literature 1 may be used for instance.

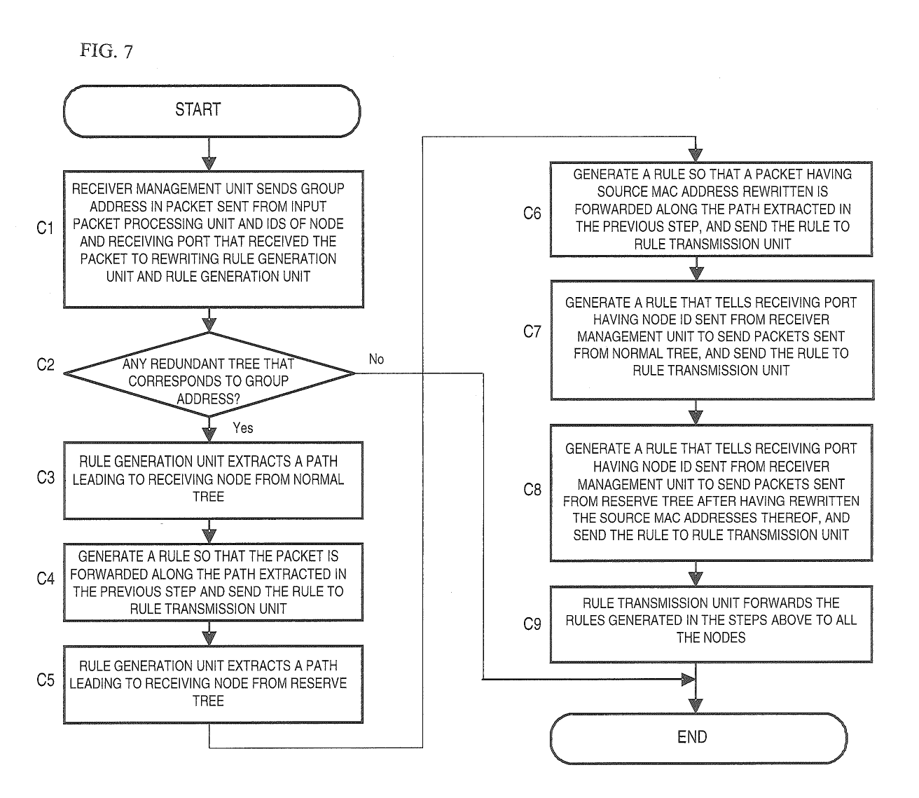

Next, an operation of the receiver management unit 31 receiving a packet from the input packet processing unit 21 will be described with reference to a flowchart shown in FIG. 7. The receiver management unit 31 sends the group address in an IGMP or MLD packet sent from the input packet processing unit 21 and the IDs of the node that received the packet and the receiving port to the rewriting rule generation unit 37 and the rule generation unit 35 (step CO.

The rule generation unit 35 refers to the group address sent from the receiver management unit 31, and searches the redundant tree sent from the redundant tree calculation unit 33 to see if there is a corresponding pair of the normal and reserve trees (step C2). When there is no corresponding redundant tree (No in the step C2), the rule generation unit 35 ends the processing.

Meanwhile, when there is a corresponding redundant tree (Yes in the step C2), the rule generation unit 35 extracts a path leading to the node (receiving node) that received the packet sent from the receiver management unit 31 from the normal tree sent from the redundant tree calculation unit 33 (step C3).

For instance, the node 15 is assumed to be the receiving node in the network shown in FIG. 3. At this time, a path on the normal tree (dotted line) leading from the node 11 to the node 15 via the node 12 is extracted. Next, the rule generation unit 35 generates a rule so that the packet is forwarded along the path extracted in the step C3 and sends the rule to the rule transmission unit 23 (step C4).

In the example shown in FIG. 3, a rule that tells the node 11 to forward a packet that matches the matching rules in FIG. 4A to the node 12 is generated. Meanwhile, a rule that tells the node 12 to forward this packet to the node 15 is generated.

Next, the rule generation unit 35 extracts a path leading the receiving node from the reserve tree as in the step C3 (step C5). Further, the rule generation unit 35 generates a rule so that a packet having the source MAC address rewritten is forwarded along the path extracted in the step C5, and sends the rule to the rule transmission unit 23 (step C6).

In the network shown in FIG. 3, a path (dashed line) leading from the node 11 to the node 15 via the node 14 is extracted. At this time, a rule that tells the node 11 to forward a packet that matches the matching rules in FIG. 4B to the node 14 is generated. Meanwhile, a rule that tells the node 14 to forward this packet to the node 15 is generated.

Next, the rule generation unit 35 generates a rule that tells the receiving port having the node ID sent from the receiver management unit 31 to send packets sent from the normal tree, and sends the rule to the rule transmission unit 23 (step C7).

Then, the rule generation unit 35 generates a rule that tells the receiving port having the node ID sent from the receiver management unit 31 to send packets sent from the reserve tree after having rewritten the source MAC addresses thereof, and sends the rule to the rule transmission unit 23 (step C8).

In the network shown in FIG. 3, the rule generation unit 35 generates a rule that outputs a packet matching the matching rules in FIG. 4A without doing anything and outputs a packet matching the matching rules in FIG. 4B after having rewritten the source MAC address to WW:WW:WW:11:11:11 to the port that the recipient is connected to.

Next, the rule transmission unit 23 forwards the rules generated in the steps above to all the nodes (step C9).

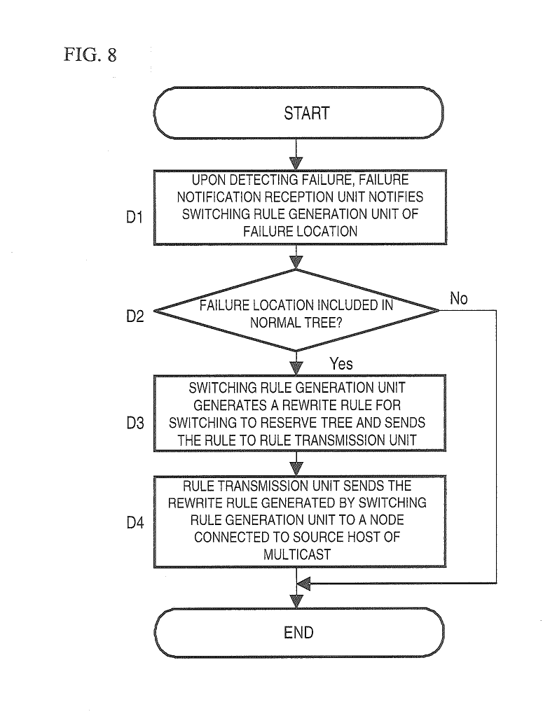

An operation when a failure occurs will be described with reference to a flowchart shown in FIG. 8. Upon detecting a failure, the failure notification reception unit 22 notifies the switching rule generation unit 36 of the failure location (step D1).

For instance, when a notification indicating a change to a link-down state in a Port-status message is received from a node, it is determined that a failure has occurred in the link connected to the port in question. Further, when the secure channel is disconnected, it is determined that a failure has occurred in the node in question. Other than these, Flow-Removed messages can be used. When a failure occurs, packets do not reach the nodes located downstream from the failure location. At this time, a timeout occurs in a flow entry for forwarding a packet along the normal tree, and a Flow-Removed message is transmitted to the control apparatus 4. The failure location may be determined by collecting Flow-Removed messages transmitted by all the nodes and identifying the location between the nodes that have sent Flow-Removed messages and the other nodes. Further, a failure location may be detected based on other methods.

Next, the switching rule generation unit 36 determines whether or not the failure location is included in the normal tree (step D2).

For instance, when a failure occurs in the link between the nodes 14 and 15 in the network shown in FIG. 3, the failure location is not included in the normal tree since this link is not used in the normal tree (No in the step D2). At this time, the sequence of processing ends because there is no need to switch the path.

Meanwhile, when a failure occurs in the link between the nodes 12 and 13, the failure location is included in the normal tree since this link is used in the normal tree (Yes in the step D2). When the failure location is included in the normal tree (Yes in the step D2), the switching rule generation unit 36 generates a rewrite rule for switching to the reserve tree and sends the rule to the rule transmission unit 23 (step D3).

In the network shown in FIG. 3, the action of this rewrite rule is to “rewrite from WW:WW:WW:11:11:11 to VV:VV:VV:00:00:01.”

The rule transmission unit 23 sends the rewrite rule generated by the switching rule generation unit 36 to the node connected to the source host of the multicast (step D4).

In the network illustrated in FIG. 3, the rule transmission unit 23 sends the rewrite rule to the node 11 connected to the multicast source host.

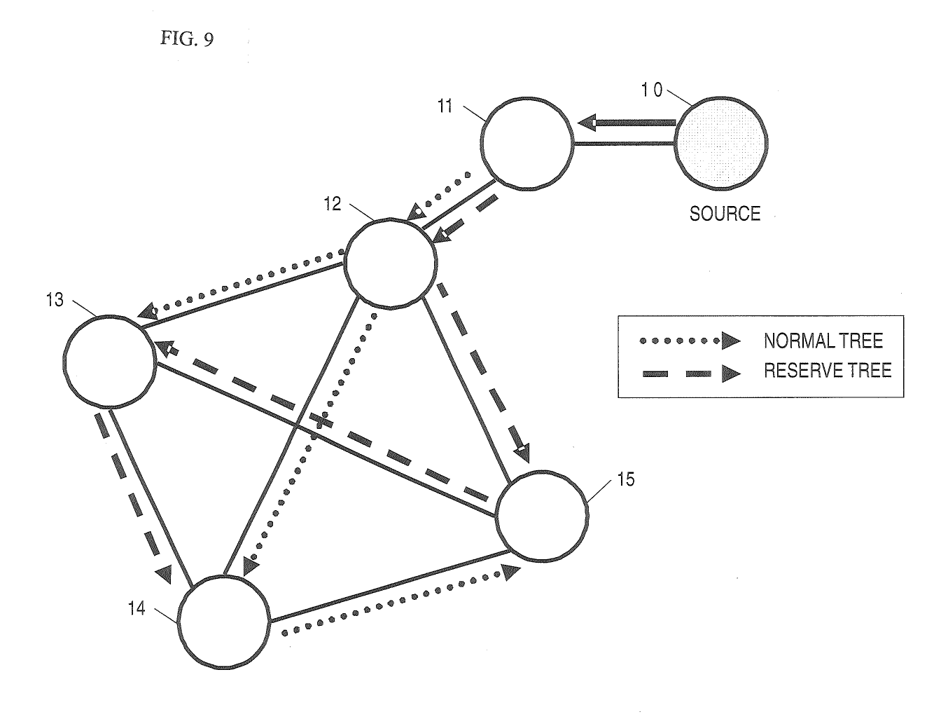

Further, in the step D4, the rule transmission unit 23 sends the rewrite rule generated by the switching rule generation unit 36 to the node connected to the multicast source host, but it may send the rule to another node. For instance, in the network in FIG. 9, the link between the nodes 11 and 12 is shared by the normal tree and the reserve tree. In such a configuration, the rule transmission unit 23 may send the rewrite rule to the node 12, instead of the node 11, which is the node connected to the multicast source host.

### Second Exemplary Embodiment

A control apparatus relating to a second exemplary embodiment will be described with reference to the drawings.

The control apparatus 4 of the first exemplary embodiment switches a path in multicast packet forwarding. Meanwhile, the control apparatus 4 of the present exemplary embodiment switches a path in unicast packet forwarding.

FIG. 10 is a block diagram showing a configuration of the control apparatus 4 relating to the present exemplary embodiment as an example. With reference to FIG. 10, the control apparatus 4 of the present exemplary embodiment comprises a packet transmission unit 24, a packet analysis unit 39, a path table 40, and a redundant path calculation unit 41, instead of the sender management unit 32, the receiver management unit 31, and the redundant tree calculation unit 33 in the control apparatus 4 of the first exemplary embodiment (FIG. 2).

Unlike multicast, the destination address is written in the header of a received packet in unicast. This eliminates the need to manage recipients separately, and from which port of which node a packet should be outputted can be determined based on information in the path table 40.

The packet analysis unit 39 refers to the destination address of a packet sent from the input packet processing unit 21, determines the output node and port, which will be the output, from the path table 40, and sends the packet itself to the packet transmission unit 24 along with these pieces of information. Further, the packet analysis unit 39 sends the input node and port number that received the packet, and the packet header to the redundant path calculation unit 41, in addition to the output node and port number. Further, the packet analysis unit 39 sends a set of the packet's source IP address and source MAC address to the address management unit 38.

The path table 40 is a table for managing a set of information comprised of the destination, mask length, output node ID, and output port number. These pieces of information included in the path table 40 are set in advance using some sort of means.

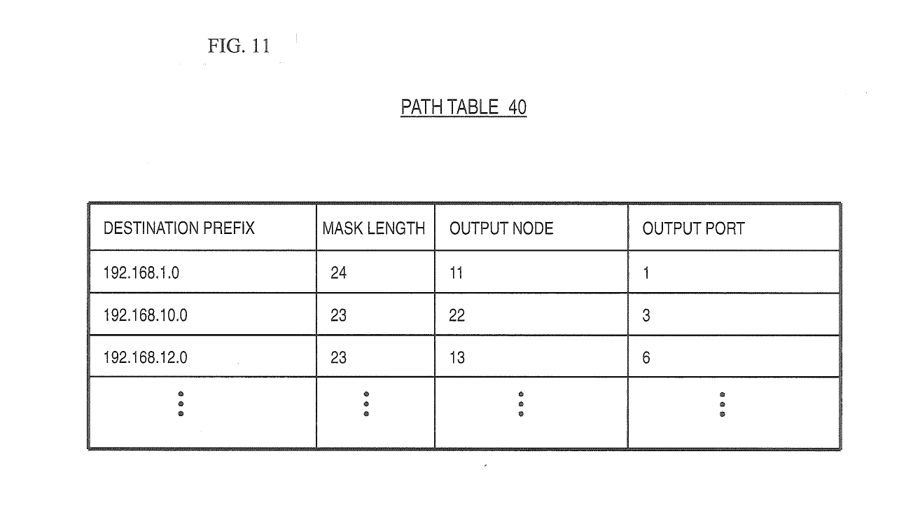

FIG. 11 shows a configuration of the path table 40 as an example. For instance, when the destination prefix is 192.168.1.1, the output node is 11 and the output port is the first port since the packet corresponds to the first entry.

The node forwards the second and subsequent packets out of packets constituting a flow according to a rule generated by the rule generation unit 35. Since the first packet is sent to the control apparatus 4 by the Packet-in message, the first packet needs to be sent to the output node, which is the output, from the control apparatus 4. Therefore, the packet transmission unit 24 sends a Packet-out message to the designated output node so that the packet sent from the packet analysis unit 39 is outputted from the designated port. This makes it possible to deliver the first packet of the flow to the destination.

The redundant path calculation unit 41 calculates a redundant path (combination of normal and reserve paths) leading from the input node to the output node sent from the packet analysis unit 39. Here, the redundant path can be calculated by calculating a redundant tree using the method described in the first exemplary embodiment and extracting a path leading to a specific output node from the redundant tree.

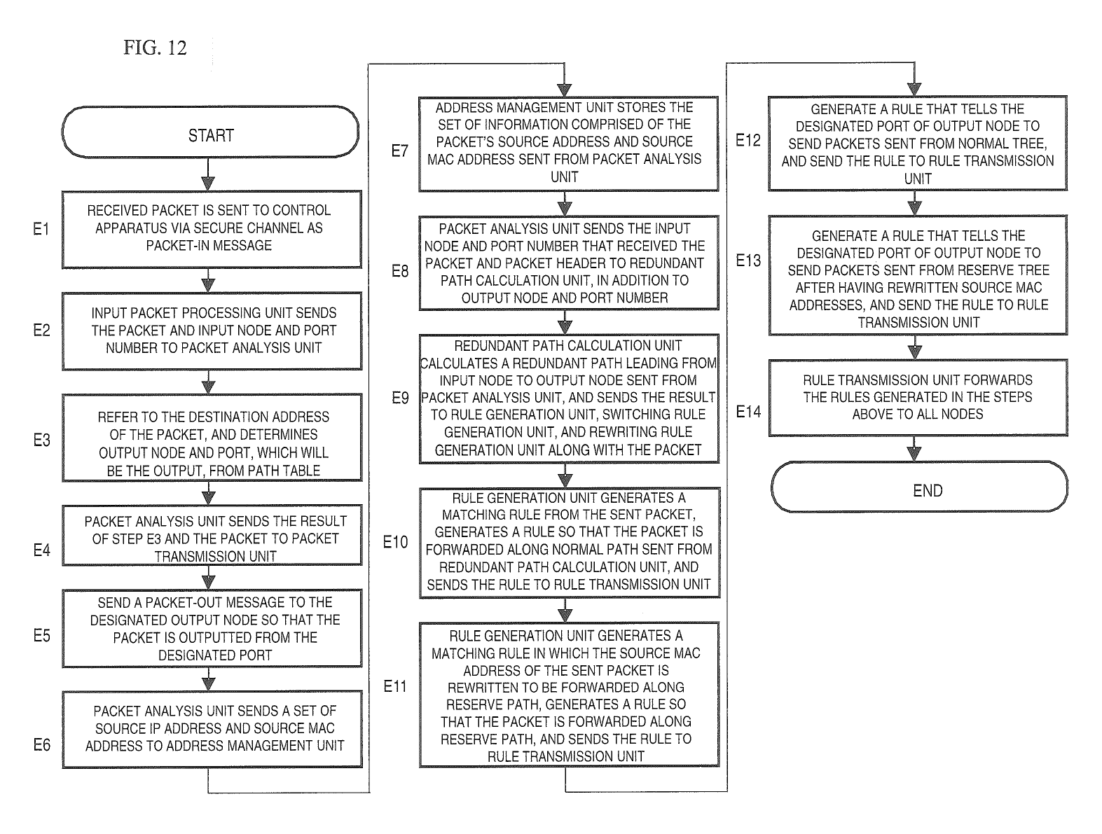

Next, an operation of receiving a packet will be described with reference to a flowchart in FIG. 12.

A packet received by a node is sent to the control apparatus 4 via the secure channel as a Packet-in message (step E1).

Upon receiving the message sent to the control apparatus 4, the input packet processing unit 21 sends the packet and the input node and port number that received the packet to the packet analysis unit 39 (step E2).

The packet analysis unit 39 refers to the destination address of the packet, and determines the output node and port, which will be the output, from the path table 40 (step E3).

The packet analysis unit 39 sends the results of the step E3 and the packet to the packet transmission unit 24 (step E4). The packet transmission unit 24 sends a Packet-out message to the designated output node so that the packet is outputted from the designated port (step E5).

The packet analysis unit 39 sends a set of the source IP address and the source MAC address to the address management unit 38 (step E6). The address management unit 38 stores the set of information comprised of the packet's source address and source MAC address sent from the packet analysis unit 39 (step E7).

The packet analysis unit 39 sends the input node and port number that received the packet, and the packet header to the redundant path calculation unit 41, in addition to the output node and port number (step E8). The redundant path calculation unit 41 calculates a redundant path leading from the input node to the output node sent from the packet analysis unit 39, and sends the result to the rule generation unit 35, the switching rule generation unit 36, and the rewriting rule generation unit 37 along with the packet (step E9).

The rule generation unit 35 generates a matching rule from the sent packet, generates a rule so that the packet is forwarded along the normal path sent from the redundant path calculation unit 41, and sends the rule to the rule transmission unit 23 (step E10). Further, the rule generation unit 35 generates a matching rule in which the source MAC address of the sent packet is rewritten to be forwarded along the reserve path, generates a rule so that the packet is forwarded along the reserve path sent from the redundant path calculation unit 41, and sends the rule to the rule transmission unit 23 (step E11).

The matching rules included in the rule are the same as the matching rules shown in FIGS. 4A and 4B, except for the differences between multicast and unicast.

Next, the rule generation unit 35 generates a rule that tells the designated port of the output node to send packets sent from the normal tree, and sends the rule to the rule transmission unit 23 (step E12). Further, the rule generation unit 35 generates a rule that tells the designated port of the output node to send packets sent from the reserve tree after having rewritten the source MAC addresses thereof, and sends the rule to the rule transmission unit 23 (step E13).

Then, the rule transmission unit 23 forwards the rules generated in the steps above to all the nodes (step E14).

A switching operation when a failure occurs is nearly the same as the case of multicast in the first exemplary embodiment. In the case of multicast, whether or not the failure location is in the normal tree is determined. Meanwhile, in the case of unicast in the present exemplary embodiment, whether or not the failure location is in the normal path is determined.

For instance, the control apparatus relating to the present invention can be utilized as an OpenFlow Controller (OFC) when a highly reliable network is constructed using OpenFlow.

The disclosure of the above Patent Literatures and Non-Patent Literature is incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### REFERENCE SIGNS LIST

1: secure channel
2: switch management unit
3: tree management unit
4: control apparatus
10: source node
11 to 15: node
21: input packet processing unit
22: failure notification reception unit
23: rule transmission unit
24: packet transmission unit
31: receiver management unit
32: sender management unit
33: redundant tree calculation unit
34: topology management unit
35: rule generation unit
36: switching rule generation unit
37: rewriting rule generation unit
38: address management unit
39: packet analysis unit
40: path table
41: redundant path calculation unit
43: path calculation unit

What is claimed is:

1. A control method, comprising:
by a control apparatus, calculating first and second paths that share start and end nodes out of a plurality of nodes;
generating a first rule for forwarding a packet along the first path and a second rule for forwarding a packet along the second path;
sending the first and the second rules to at least one of the plurality of nodes; and
having at least one of the plurality of nodes forward a packet according to either the first rule or the second rule.

2. The control method according to claim 1, wherein
the first rule includes as a matching rule for the packet a first identifier that identifies the first path, and
the second rule includes as a matching rule for the packet a second identifier that identifies the second path.

3. The control method according to claim 2, further comprising:
by the control apparatus, generating a third rule for rewriting a field included in a packet header of the packet from the first identifier to the second identifier and sending the third rule to the start node out of the plurality of nodes.

4. The control method according to claim 3, wherein
the third rule includes the first identifier as a matching rule for the packet.

5. The control method according to claim 1, wherein
the packet comprises a unicast packet,
the start node comprises a node first to receive the unicast packet out of the plurality of nodes, and
the end node comprises a node selected from the plurality of nodes based on a destination address included in the unicast packet.

6. The control method according to claim 1, wherein
the packet comprises a multicast packet,
the start node comprises a node first to receive the multicast packet out of the plurality of nodes, and
the end node comprises a node connected to a multicast receiver terminal that participates in a group indicated by a destination address of the multicast packet out of the plurality of nodes.

7. The control method according to claim 6, further comprising:
by the control apparatus, storing an association between a node, that received a participation notification packet notifying participation in a multicast group transmitted from a multicast receiver terminal, and the multicast receiver terminal.

8. The control method according to claim 3, further comprising:
by the control apparatus, detecting a failure in the plurality of nodes or a link between the plurality of nodes.

9. The control method according to claim 8, wherein
the control apparatus generates and sends the third rule to a node that corresponds to the start node out of the plurality of nodes when the failure is detected in the first path.

10. The control method according to claim 8, wherein
the control apparatus detects the failure based on timeout of the first rule.

11. The control method according to claim 3, wherein
a field rewritten according to the third rule is a source layer 2 address field.

12. The control method according to claim 3, further comprising:
by the control apparatus, generating a fourth rule that rewrites a field included in a packet header of the packet from the second identifier to the first identifier, and sending the fourth rule to a node corresponding to the end node out of the plurality of nodes.

13. The control method according to claim 12, wherein
the fourth rule includes the second identifier as a matching rule for the packet.

14. A control apparatus, comprising:
a path calculation unit that calculates first and second paths sharing start and end nodes out of a plurality of nodes;
a rule generation unit that generates a first rule for forwarding a packet along the first path and a second rule for forwarding a packet along the second path; and
a rule transmission unit that sends the first and the second rules to at least one of the plurality of nodes, and has at least one of the plurality of nodes forward a packet according to either the first rule or the second rule.

15. The control apparatus according to claim 14, wherein
the first rule includes as a matching rule for the packet a first identifier that identifies the first path, and
the second rule includes as a matching rule for the packet a second identifier that identifies the second path.

16. The control apparatus according to claim 15, further comprising:
a switching rule generation unit that generates a third rule for rewriting a field included in a packet header of the packet from the first identifier to the second identifier, wherein
the rule transmission unit sends the third rule to a node corresponding to the start node out of the plurality of nodes.

17. The control apparatus according to claim 16, wherein
the third rule includes the first identifier as a matching rule for the packet.

18. The control apparatus according to claim 14, wherein
the packet comprises a unicast packet,
the start node comprises a node first to receive the unicast packet out of the plurality of nodes, and
the end node comprises a node selected from the plurality of nodes based on a destination address included in the unicast packet.

19. The control apparatus according to claim 14, wherein
the packet comprises a multicast packet,
the start node comprises a node first to receive the multicast packet out of the plurality of nodes, and
the end node comprises a node connected to a multicast receiver terminal that participates in a group indicated by a destination address of the multicast packet out of the plurality of nodes.

20. The control apparatus according to claim 19, further comprising:
a storage unit that stores an association between a node, that received a participation notification packet notifying participation in a multicast group transmitted from a multicast receiver terminal, and the multicast receiver terminal.

21. The control apparatus according to claim 16, further comprising:
a failure notification reception unit that detects a failure in the plurality of nodes or a link between the plurality of nodes.

22. The control apparatus according to claim 21, wherein
the switching rule generation unit generates the third rule when the failure is detected in the first path.

23. The control apparatus according to claim 16, further comprising:
a rewriting rule generation unit that generates a fourth rule that rewrites a field included in a packet header of the packet from the second identifier to the first identifier, wherein
the rule transmission unit sends the fourth rule to a node corresponding to the end node out of the plurality of nodes.

24. The control apparatus according to claim 23, wherein
the fourth rule includes the second identifier as a matching rule for the packet.

25. A non-transitory computer-readable recording medium, storing a program that causes a computer to execute:
calculating first and second paths that share start and end nodes out of a plurality of nodes;
generating a first rule for forwarding a packet along the first path and a second rule for forwarding a packet along the second path; and
sending the first and the second rules to at least one of the plurality of nodes, and having at least one of the plurality of nodes forward a packet according to either the first rule or the second rule.

26. The non-transitory computer-readable recording medium according to claim 25, wherein
the first rule includes as a matching rule for the packet a first identifier that identifies the first path, and
the second rule includes as a matching rule for the packet a second identifier that identifies the second path.

27. The non-transitory computer-readable recording medium according to claim 26, wherein
the program further causes the computer to execute:
generating a third rule for rewriting a field included in a packet header of the packet from the first identifier to the second identifier, and sending the third rule to a node corresponding to the start node out of the plurality of nodes.

28. The non-transitory computer-readable recording medium according to claim 27, wherein
the third rule includes the first identifier as a matching rule for the packet.

29. The non-transitory computer-readable recording medium according to claim 25, wherein
the packet comprises a unicast packet,
the start node comprises a node first to receive the unicast packet out of the plurality of nodes, and
the end node comprises a node selected from the plurality of nodes based on a destination address included in the unicast packet.

30. The non-transitory computer-readable recording medium according to claim 25, wherein
the packet is a multicast packet,
the start node is a node first to receive the multicast packet out of the plurality of nodes, and
the end node is a node connected to a multicast receiver terminal that participates in a group indicated by a destination address of the multicast packet out of the plurality of nodes.

31. The non-transitory computer-readable recording medium according to claim 30, wherein
the program further causes the computer to execute:
storing an association between a node, that received a participation notification packet notifying participation in a multicast group transmitted from a multicast receiver terminal, and the multicast receiver terminal.

32. The non-transitory computer-readable recording medium according to claim 27, wherein
the program further causes the computer to execute:
detecting a failure in the plurality of nodes or a link between the plurality of nodes.

33. The non-transitory computer-readable recording medium according to claim 32, wherein
the program causes the computer to execute:
generating and forwarding the third rule to a node that corresponds to the start node out of the plurality of nodes when the failure is detected in the first path.

34. The non-transitory computer-readable recording medium according to claim 27, wherein
the program further causes the computer to execute:
generating a fourth rule that rewrites a field included in a packet header of the packet from the second identifier to the first identifier, and sending the fourth rule to a node corresponding to the end node out of the plurality of nodes.

35. The non-transitory computer-readable recording medium according to claim 34, wherein
the fourth rule includes the second identifier as a matching rule for the packet.

36. A communication system, comprising:
a plurality of nodes; and
a control apparatus, wherein
the control apparatus includes:
a path calculation unit that calculates first and second paths that share start and end nodes out of the plurality of nodes;
a rule generation unit that generates a first rule for forwarding a packet along the first path and a second rule for forwarding a packet along the second path; and
a rule transmission unit that sends the first and the second rules to at least one of the plurality of nodes, and
at least one of the plurality of nodes forwards the packet according to either the first rule or the second rule.

37. The communication system according to claim 36, wherein
the first rule includes as a matching rule for the packet a first identifier that identifies the first path, and
the second rule includes as a matching rule for the packet a second identifier that identifies the second path.

38. The communication system according to claim 37, wherein
the control apparatus further includes a switching rule generation unit that generates a third rule for rewriting a field included in a packet header of the packet from the first identifier to the second identifier, and
the rule transmission unit sends the third rule to a node corresponding to the start node out of the plurality of nodes.

39. The communication system according to claim 38, wherein
the third rule includes the first identifier as a matching rule for the packet.

40. The communication system according to claim 36, wherein
the packet comprises a unicast packet,
the start node comprises a node first to receive the unicast packet out of the plurality of nodes, and
the end node comprises a node selected from the plurality of nodes based on a destination address included in the unicast packet.

41. The communication system according to claim 36, wherein
the packet comprises a multicast packet,
the start node comprises a node first to receive the multicast packet out of the plurality of nodes, and
the end node comprises a node connected to a multicast receiver terminal that participates in a group indicated by a destination address of the multicast packet out of the plurality of nodes.

42. The communication system according to claim 41, wherein
the control apparatus further includes a storage unit, that stores an association between a node that received a participation notification packet notifying participation in a multicast group transmitted from a multicast receiver terminal, and the multicast receiver terminal.

43. The communication system according to claim 38, wherein
the control apparatus further includes a failure detection unit that detects a failure in the plurality of nodes or a link between the plurality of nodes.

44. The communication system according to claim 43, wherein
the switching rule generation unit generates the third rule when the failure is detected in the first path.

45. The communication system according to claim 43, wherein
the failure detection unit detects the failure based on timeout of the first rule.

46. The communication system according to claim 38, wherein
a field rewritten according to the third rule is a source layer 2 address field.

47. The communication system according to claim 38, wherein
the control apparatus further includes a rewriting rule generation unit that generates a fourth rule that rewrites a field included in a packet header of the packet from the second identifier to the first identifier, and
the rule transmission unit sends the third rule to a node corresponding to the start node out of the plurality of nodes.

48. The communication system according to claim 47, wherein
the fourth rule includes the second identifier as a matching rule for the packet.
